(19) United States
(12) Patent Application Publication
(10) Pub. No.: US 2026/0188130 A1
(43) Pub. Date: Jul. 2, 2026

(54) STATIONARY OBJECT COLLISION AVOIDANCE SYSTEM

(71) Applicant: Southwest Research Institute, San Antonio, TX (US)

(72) Inventor: Peter Mark LEE, Fair Oaks Ranch, TX (US)

(21) Appl. No.: 19/421,104

(22) Filed: Dec. 16, 2025

Related U.S. Application Data
(60) Provisional application No. 63/739,796, filed on Dec. 30, 2024.

(51) Int. Cl. G08G 5/80; G08G 5/59; G08G 5/72

(52) U.S. Cl. CPC G08G 5/80; G08G 5/59; G08G 5/727

(57) ABSTRACT

In an approach to detecting stationary objects in a traffic alert and collision avoidance system. The method includes supplying an aircraft with a collision avoidance system (CAS) wherein the CAS provides a display for stationary object detection; providing a stationary object with a transponder where the CAS interrogates the stationary object transponder and determines a height and distance of the stationary object relative to the aircraft; wherein the CAS determines a range, bearing and relative altitude of the aircraft relative to the stationary object and: issues either a visual or audible alert; and/or in the case of the stationary object having a lighting system, the CAS provides instructions to the lighting system to increase in lighting intensity or enter a strobe mode of operation.

### CROSS-REFERENCE TO RELATED APPLICATIONS

The present application claims the benefit of the filing date of U.S. Provisional Application Ser. No. 63/739,796, filed Dec. 30, 2024, the entire teachings of which application is hereby incorporated herein by reference.

### FIELD

The present invention stands directed at a traffic alert and collision avoidance system for aircraft that provides a defense to both mid-air collisions between aircraft along with the ability to reduce and/or eliminate controlled flight into natural terrain (CFIT) or man-made structures. In particular, controlled flight into elevated stationary objects such as towers, buildings and naturally formed terrain of elevated height.

### BACKGROUND

The Traffic Alert and Collision Avoidance (TCAS) system, also known as the Airborne Collision Avoidance System (ACAS), is designed to increase cockpit awareness of nearby aircraft. It acts as a defense against midair collisions (MAC). The system monitors airspace around an aircraft for other transponder equipped aircraft that may present a collision threat. TCAS operates independently of ground-based equipment to provide pilots with guidance on how to avoid a potential collision. The TCAS system display can be integrated in the navigation display or electronic horizontal situation indicator (EHSI).

While there are a variety of terrain awareness systems that provide warning to pilots, based upon the use of radar altimeters, a need remains for a more integrated stationary object collision system that can rely upon transponders positioned both on moving aircraft and on elevated natural and man-made objects. Such might then provide pilots with relatively more accurate situational awareness when piloting an aircraft through relatively heavy air-traffic regions where there may be elevated obstacles presenting hazards to safe-flying conditions.

### SUMMARY

Method of detecting stationary objects in a traffic alert and collision avoidance system comprising: (a) supplying an aircraft with a traffic alert and collision avoidance system (CAS) wherein said CAS system provides a display for stationary object detection; (b) providing a stationary object with a transponder where the CAS system interrogates the stationary object transponder and determines the height, bearing and distance of said stationary object relative to the aircraft; and (c) wherein said CAS determines a range, bearing and relative altitude of said aircraft relative to the stationary object and: (i) issues either a visual or audible alert; and/or (ii) in the case of the stationary object having a lighting system, the CAS provides instructions to the lighting system to increase in lighting intensity or enter into a strobe mode of operation.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a system 100 for traffic alerting and collision avoidance consistent with the present disclosure.

FIG. 2 is an example of the system 100 for traffic alerting and collision avoidance of FIG. 1 showing a commercial aircraft interrogating a cellular tower consistent with the present disclosure.

FIG. 3 is a flowchart diagram depicting a process 300 for one illustrative example embodiment of a method for traffic alerting and collision avoidance, on the system of FIG. 1, consistent with the present disclosure.

### DETAILED DESCRIPTION

The airborne collision avoidance system (ACAS) was developed as a safety-enhancing system to reduce the likelihood of mid-air collisions between aircraft. ACAS iterations include Traffic Alert and Collision Avoidance System (TCAS) I, TCAS II, and ACAS Xa. TCAS I provides Traffic Advisories (TAs) that indicate on a display the positions and relative altitudes (if the target is altitude reporting) of transponder operating aircraft to assist a flight crew in the visual acquisition of aircraft with a potential for collision. ACAS II (TCAS II or ACAS Xa) provides both TAs and Resolution Advisories (RAs). RAs are recommended vertical maneuvers, or vertical maneuver restrictions that maintain or increase the vertical separation between aircraft for collision avoidance. ACAS Xo is an extension of ACSXa that is designed for specific operations, such as relatively closely spaced parallel aircraft approaches.

Aircraft can therefore interrogate other transponder-equipped aircraft within an area via 1030 MHz and the transponders on other aircraft reply via 1090 MHz. This response gives the geolocation and trajectory of the aircraft. Depending on the transponder used, around 40-60 aircraft can communicate simultaneously. The TCAS system can build a three-dimensional map of aircraft in the selected airspace, identifying their range (from interrogation and response round trip time), altitude (as reported by the interrogated aircraft) and bearing (by the directional antenna from the response). By extrapolating the current range and altitude difference to anticipated future values, the TCAS system can determine the presence of a potential collision.

To prevent over stimulation of the pilot, a transponder system employed with TCAS may be configured to preferably display up to eight (8) aircraft that are determined to pose the greatest relative threat at that time and which aircraft are within 2,700 ft below to 9,900 ft above or 2,700 ft above to 9,900 ft below the aircraft, depending on whether the aircraft itself is climbing or descending. In addition, the system preferably has four regions around the aircraft, increasing in perimeter. The furthest perimeter area is classed as “Others,” and no action is announced by the system. The next smallest area perimeter is called “Proximate” or “Intruder” and this may show on the TCAS screen as observed by the pilot. The next smallest area is called “Traffic Advisory” (TA), and an alert will sound in the cockpit such as “TRAFFIC TRAFFIC.” If the aircraft enters the closest zone, it becomes a “Resolution Advisory” (RA) and the sound “COLLISION COLLISION” will alert the pilot and instructions to avoid a collision are provided.

The TCAS system therefore preferably works out the best resolution and sends instructions to both aircraft. Pilots are advised that safety instructions received from TCAS are to take precedence over instructions from Air Traffic Control (ATC). In the current version of what is known as TCAS II, information regarding a near collision is automatically sent to ATC. TCAS II similarly will provide a Traffic Advisory and Resolution Advisory, with reliable surveillance up to 14 nautical miles (nm), head-on closing speeds of up to 1200 knots, reliability with traffic densities up to 24 transponder aircraft within 5 nm of the user, and other traffic positions updated at 1 Hz.

While TCAS is therefore designed to mitigate collisions with other aircraft, it can be appreciated that with aircraft flying relatively close to the ground, the risk of colliding with natural terrain or man-made structures increases. This is particularly the case on approach and/or takeoff, or with respect to aircraft flying at night at relatively low altitudes, under visual flight rule (VFR) conditions, or in flights on instrument flight rules (IFR). Such is often identified as controlled flight into terrain or CFIT.

For example, man-made towers have flashing lights to improve their visibility during both day and night. However, these lights can fail or become less prominent over time. Accordingly, pilots can be called upon to observe and detect the stationary towers and accompanying guy wires without light identification. When looking up to the sky from the ground, towers can be relatively more obvious as they are silhouetted against the sky. However, when looking down from an aircraft they may not be as easily observable due to the darker and optically busy nature of the ground.

To therefore improve on CAS and pilot situational awareness, it is contemplated herein that one may now provide for the addition of elevated natural terrain or man-made stationary objects to CAS systems such as the TCAS II and ACAS Xa/Xo system. The algorithms utilized for evaluation and detection of target aircraft with transponders resulting in either a Traffic Advisory or Resolution Advisory is contemplated to be adjusted to accommodate the stationary attributes of either a man-made or naturally formed elevated stationary object that may raise the risk of controlled flight into terrain (CFIT). Such algorithm is contemplated to rely upon the stationary object height above ground, stationary object relative footprint (to allow, e.g., for the presence of guy wires in the case of a tower), and the speed and direction of the closing aircraft, as well as the aircraft's flying capabilities. The Traffic Advisory call out is contemplated to be conveniently altered to a Traffic Advisory call-out such as “TOWER TOWER” or “TERRAIN TERRAIN” or a Resolution Advisory such as “GROUND COLLISION GROUND COLLISION.” In such manner, the pilot is alerted to the fact that the warning is with respect to a stationary non-moving object, as opposed to a target aircraft.

In addition, it is contemplated herein that, e.g., a given stationary object such as a tower, may be configured such that should the CAS system interrogate the transponder assigned to the tower, and extrapolate the range of the aircraft to the tower and altitude difference to anticipated future values, and determine the presence of a potential collision, the CAS system may not only issue a Traffic Advisory or Resolution Advisory, the CAS system may also provide instructions to the tower to adjust the tower lighting system or associated guy wire lights to, e.g., increase in lighting intensity or enter into a strobe mode of operation in order to increase the tower's visual detection by the pilots of the approaching aircraft.

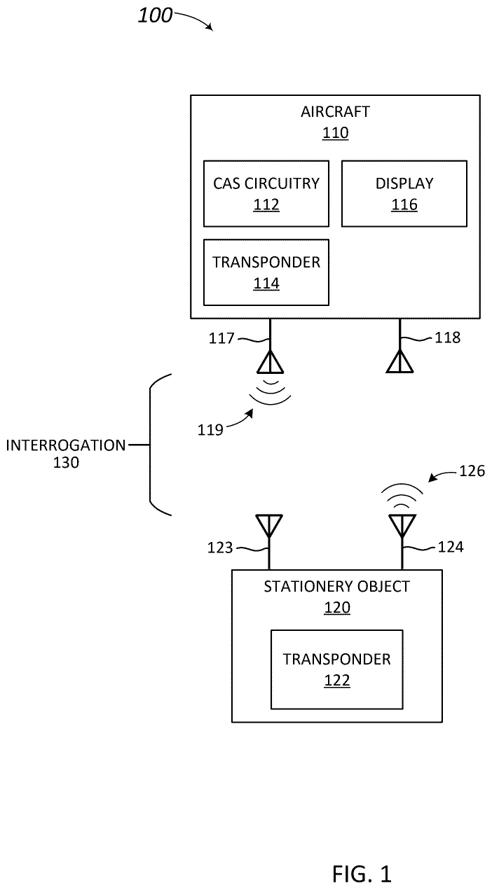

FIG. 1 is a functional block diagram illustrating a system 100 for traffic alerting and collision avoidance consistent with the present disclosure. The system 100 includes an aircraft 110 and a stationary object 120. The stationary object 120 may be, for example, a radio or television transmission tower, a cellular tower, etc. The aircraft 110 includes CAS circuitry 112, a transponder 114, and a display 116. In some embodiments, the CAS circuitry 112 may be, for example, a TCAS I, TCAS II, or ACAS Xa system. In some other embodiments, the CAS circuitry 112 may be a stand-alone device. In some embodiments, the transponder 114 may be the aircraft's Mode-S transponder. In some other embodiments, the transponder 114 may a separate transponder incorporated into the CAS circuitry 112. In some embodiments, the display 116 may be integrated into other cockpit displays in the aircraft 110. During an interrogation 130, the aircraft 110 transmits an interrogation signal 119 via the transponder 114 and a transmit antenna 117 and receives any responses to the interrogation signal 119 via a receive antenna 118.

The stationary object 120 includes a transponder 122 that is configured to receive the interrogation signal 119 via a receive antenna 123 and to transmit a response 126 via a transmission antenna 124 to the aircraft 110.

As therefore may be appreciated, the present invention provides a method of detecting stationary objects in a traffic alert and collision avoidance system. One first supplies an aircraft with a CAS system wherein the CAS system provides a display for stationary object detection. One or more stationary objects may now be provided with a transponder where the CAS interrogates the stationary object transponder and determines the height, bearing and distance of said stationary object relative to said aircraft. The CAS then determines a range, bearing and relative altitude of said aircraft relative to said stationary object and (i) issues either a visual or audible alert; and/or (ii) in the case of the stationary object having a lighting system, the CAS provides instructions to the lighting system to increase in lighting intensity or enter into a strobe mode of operation.

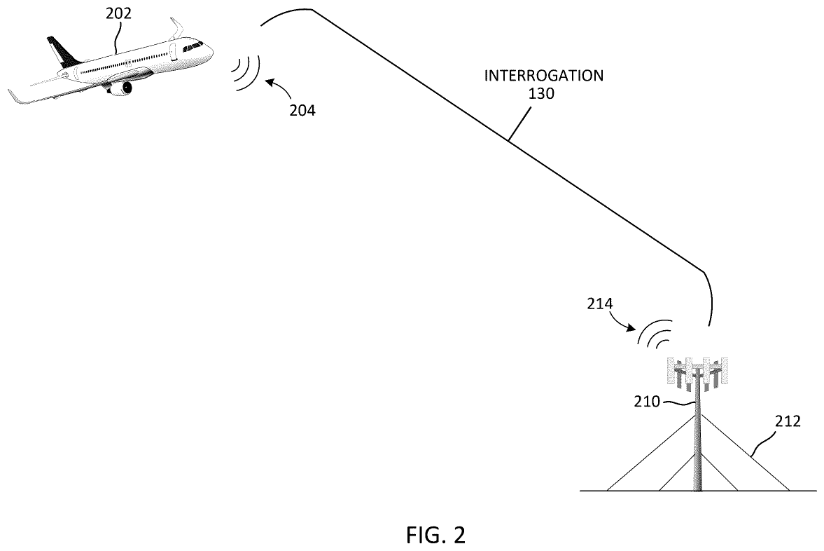

FIG. 2 is an example of the system 100 for traffic alerting and collision avoidance of FIG. 1 showing a commercial aircraft interrogating a cellular tower consistent with the present disclosure. In the example of FIG. 2, an aircraft 202, which may be the aircraft 110 from FIG. 1, transmits an interrogation signal 204 during an interrogation 130. In response to the interrogation signal 204 from the aircraft 202, a stationary object, in this example a cellular tower 210, receives the interrogation signal 204 from the aircraft 202 and sends a response 214. The response may include, but is not limited to, the height above ground of the stationary object 210, and the stationary object relative footprint (to allow, e.g., for the presence of guy wires 212 in the case of a tower or the width of a hill in the case of naturally formed terrain of elevated height). The CAS circuitry 112 in the aircraft 202 may use this data, the speed and direction of the aircraft, and the aircraft's flying capabilities to determine whether a collision is predicted.

The CAS system therefore preferably issues visual and/or aural alerts when a potential collision with the stationary object by the aircraft reaches a predetermined threshold (e.g., an alert can be provided when the system determines that the aircraft will pass less than 100 feet above the object). The CAS system also preferably includes and evaluates the operating parameters of the aircraft (e.g., maximum vertical rate of climb, maximum airspeed, etc.,) and is able to provide a resolution advisory (RA) that complies with the recommended operating parameters and performance capability of the aircraft at issue. For example, the CAS system is contemplated to consider the maximum vertical rate of climb of the aircraft at issue and evaluate the speed and bearing of the aircraft towards the stationary object at issue and advise of a vertical rate of climb or horizontal deviation that does not exceed, e.g., the maximum vertical rate of climb for the aircraft.

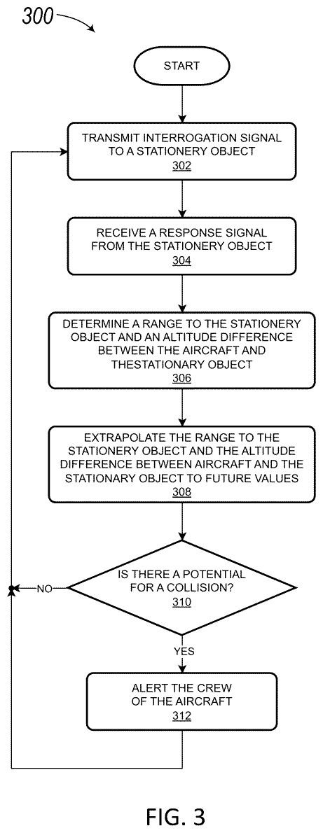

FIG. 3 is a flowchart diagram depicting a process 300 for one illustrative example embodiment of a method for traffic alerting and collision avoidance with a stationary object, on the system of FIG. 1, consistent with the present disclosure. It should be appreciated that embodiments of the present disclosure provide at least for traffic alerting and collision avoidance with a stationary object. However, FIG. 3 provides only an illustration of one implementation and does not imply any limitations with regard to the environments in which different embodiments may be implemented. Many modifications to the depicted environment may be made by those skilled in the art without departing from the scope of the disclosure as recited by the claims.

Process 300 includes transmitting an interrogation signal to a stationary object (operation 302). In the illustrated example embodiment, the aircraft, e.g., aircraft 110 from FIG. 1, transmits an interrogation signal to a stationary object, e.g., stationary object 120 from FIG. 1. In an embodiment, the interrogation signal may be a standard CAS interrogation signal such as a TCAS II interrogation signal to another aircraft. In another embodiment, the interrogation signal may be a particular interrogation signal for a stationary object.

Process 300 includes receiving a response signal from the stationary object (operation 304). In operation 304, the process 300 receives a response signal from the stationary object that may contain, but is not limited to, the height, bearing and distance of the stationary object relative to the aircraft, and the stationary object relative footprint. The stationary object relative footprint may allow for the horizontal size of objects, e.g., for the presence of guy wires in the case of a tower or the width of a hill in the case of naturally formed terrain of elevated height.

Process 300 includes determining a range to the stationary object and an altitude difference between aircraft and stationary object (operation 306). In operation 306, the process 300 determines a range, bearing, and relative altitude of the aircraft relative to the stationary object. The range may be determined from the response round trip time between the interrogation signal and the response signal. The altitude difference between aircraft and stationary object may be determined by the difference between the aircraft's current altitude and the altitude and height of the stationary object as reported by the response signal. The bearing to the stationary object may be determined by the CAS directional antenna from the response signal. By extrapolating the current range and altitude difference to anticipated future values, the process 300 can determine the presence of a potential collision. The process 300 may use this data, the speed and direction of the aircraft, and the aircraft's flying capabilities to determine whether a collision is predicted.

Process 300 includes extrapolating the range to the stationary object and the altitude difference between the aircraft and the stationary object to future values (operation 308). In operation 308, the system extrapolates the current range and altitude difference between the aircraft and the stationary object to anticipated future values. The process 300 can thereby determine the presence of a potential collision.

Process 300 includes determining whether there is a potential for a collision (decision block 310). The process 300 determines whether the aircraft is on a course that may potentially result in a collision with the stationary object based on the anticipated future values of the current range and altitude difference between the aircraft and the stationary object. If the process 300 determines that there is a potential for a collision (“yes” branch, decision block 310), then the process 300 proceeds to operation 314. If the process 300 determines that there is not a potential for a collision (“no” branch, decision block 310), then the process 300 returns to operation 302 to continue to monitor for potential collisions.

Process 300 includes alerting to the crew of the aircraft (operation 312). In operation 314, since the process 300 has determined that the aircraft is on a course that may potentially result in a collision with the stationary object, the process 300 alerts the crew of the aircraft to the possible collision. In an embodiment, the alert may be either a visual or audible alert. In an embodiment, if the stationary object has a lighting system, the process 300 may provide instructions to the lighting system to increase in lighting intensity or enter into a strobe mode of operation. In an embodiment, the process 300 may use standard CAS alerts, such as those used by the TCAS II system. In some other embodiments, the process 300 may use alerts that are specific to the disclosed system.

The process 300 then returns to operation 302 to continue to monitor for potential collisions.

According to one aspect of the disclosure there is thus provided a method of detecting stationary objects in a traffic alert and collision avoidance system. The method includes supplying an aircraft with a collision avoidance system (CAS) wherein the CAS provides a display for stationary object detection; providing a stationary object with a transponder where the CAS interrogates the stationary object transponder and determines a height and distance of the stationary object relative to the aircraft; wherein the CAS determines a range, bearing and relative altitude of the aircraft relative to the stationary object and: issues either a visual or audible alert; and/or in the case of the stationary object having a lighting system, the CAS provides instructions to the lighting system to increase in lighting intensity or enter a strobe mode of operation.

According to another aspect of the disclosure, there is thus provided a method of detecting stationary objects in a traffic alert and collision avoidance system (CAS). The method includes transmitting an interrogation signal from an aircraft; receiving a response signal from a stationary object; determining a range and a bearing to the stationary object and an altitude difference between the aircraft and the stationary object; extrapolating the range to the stationary object and the altitude difference between the aircraft and the stationary object to a plurality of future values; and responsive to determining there is a potential for a collision between the aircraft and the stationary object, issuing an alert to a crew of the aircraft to the potential for the collision.

According to yet another aspect of the disclosure, there is thus provided a system for detecting stationary objects in a traffic alert and collision avoidance system. The system includes an aircraft, the aircraft further comprising: a transponder; a transmit antenna; a receive antenna; a display; and a CAS circuitry, the CAS circuitry configured to: transmit an interrogation signal from the aircraft; receive a response signal from a stationary object; determine a range and a bearing to the stationary object and an altitude difference between the aircraft and the stationary object; extrapolate the range to the stationary object and the altitude difference between the aircraft and the stationary object to a plurality of future values; and responsive to determining there is a potential for a collision between the aircraft and the stationary object, alert a crew of the aircraft to the potential for the collision.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of detecting stationary objects in a traffic alert and collision avoidance system comprising:
supplying an aircraft with a collision avoidance system (CAS) wherein the CAS provides a display for stationary object detection;
providing a stationary object with a transponder where the CAS interrogates the stationary object transponder and determines a height and distance of the stationary object relative to the aircraft;
wherein the CAS determines a range, bearing and relative altitude of the aircraft relative to the stationary object, and:
issues either a visual or audible alert; and/or
in the case of the stationary object having a lighting system, the CAS provides instructions to the lighting system to increase in lighting intensity or enter a strobe mode of operation.

2. The method of claim 1, wherein the visual or audible alert is delivered when a potential collision with the stationary object by the aircraft reaches a predetermined threshold.

3. The method of claim 1, wherein the visual or audible alert includes a traffic advisory (TA) that informs that the aircraft is within a predetermined vicinity of the stationary object.

4. The method of claim 1, wherein the visual or audible alert includes a resolution advisory (RA) that identifies deviations for the aircraft to provide a selected vertical and/or horizontal separation between the aircraft and the stationary object.

5. A method of detecting stationary objects in a traffic alert and collision avoidance system (CAS), the method comprising:
transmitting an interrogation signal from an aircraft;
receiving a response signal from a stationary object;
determining a range and a bearing to the stationary object and an altitude difference between the aircraft and the stationary object;
extrapolating the range to the stationary object and the altitude difference between the aircraft and the stationary object to a plurality of future values; and
responsive to determining there is a potential for a collision between the aircraft and the stationary object, issuing an alert to a crew of the aircraft to the potential for the collision.

6. The method of claim 5, wherein responsive to determining there is the potential for the collision between the aircraft and the stationary object, alerting the crew of the aircraft to the potential for the collision further comprises:
determining there is the potential for the collision between the aircraft and the stationary object based on the plurality of future values.

7. The method of claim 5, wherein the range to the stationary object is determined from a round trip time between the interrogation signal and the response signal.

8. The method of claim 5, wherein the bearing to the stationary object from the aircraft is determined from a directional antenna from the response signal.

9. The method of claim 5, wherein alerting the crew of the aircraft to the potential for the collision further comprises:
issuing a visual alert, an audible alert, or both.

10. The method of claim 9, wherein the visual alert or the audible alert includes a traffic advisory (TA) that informs that the aircraft is within a predetermined vicinity of the stationary object.

11. The method of claim 9, wherein the visual alert or the audible alert includes a resolution advisory (RA) that identifies deviations for the aircraft to provide a selected vertical and/or horizontal separation between the aircraft and the stationary object.

12. The method of claim 5, further comprising:
responsive to determining there is the potential for the collision between the aircraft and the stationary object, providing instructions to the stationary object to adjust a lighting system of the stationary object, one or more associated guy wire lights, or both the lighting system of the stationary object and the one or more associated guy wire lights to increase a visual detection of the stationary object by the crew of the aircraft.

13. The method of claim 12, wherein the lighting system of the stationary object, the one or more associated guy wire lights, or both the lighting system of the stationary object and the one or more associated guy wire lights are adjusted to increase in lighting intensity and/or enter into a strobe mode of operation in order to increase visual detection of the stationary object by the crew of the aircraft.

14. A system for detecting stationary objects in a traffic alert and collision avoidance system, the system comprising:
an aircraft, the aircraft further comprising:
a transponder;
a transmit antenna;
a receive antenna;
a display; and
a CAS circuitry, the CAS circuitry configured to:
transmit an interrogation signal from the aircraft;
receive a response signal from a stationary object;
determine a range and a bearing to the stationary object and an altitude difference between the aircraft and the stationary object;
extrapolate the range to the stationary object and the altitude difference between the aircraft and the stationary object to a plurality of future values; and
responsive to determining there is a potential for a collision between the aircraft and the stationary object, alert a crew of the aircraft to the potential for the collision.

15. The system of claim 14, wherein responsive to determining there is the potential for the collision between the aircraft and the stationary object, alert the crew of the aircraft to the potential for the collision further comprises:
determine there is the potential for the collision between the aircraft and the stationary object based on the plurality of future values.

16. The system of claim 14, wherein the range to the stationary object is determined from a round trip time between the interrogation signal and the response signal.

17. The system of claim 14, wherein the bearing to the stationary object from the aircraft is determined from a directional antenna from the response signal.

18. The system of claim 14, wherein alerting the crew of the aircraft to the potential for the collision further comprises:
issues a visual alert, an audible alert, or both.

19. The system of claim 18, wherein the visual alert or the audible alert includes a traffic advisory (TA) that informs that the aircraft is within a predetermined vicinity of the stationary object.

20. The system of claim 18 wherein the visual alert or the audible alert includes a resolution advisory (RA) that identifies deviations for the aircraft to provide a selected vertical and/or horizontal separation between the aircraft and the stationary object.
